(19) United States
(12) Patent Application Publication
(10) Pub. No.: US 2018/0280250 A1
(43) Pub. Date: Oct. 4, 2018

(54) BABY CALMING DEVICE

(71) Applicant: Timothy Smith, Oberlin, LA (US)

(72) Inventor: Timothy Smith, Oberlin, LA (US)

(21) Appl. No.: 15/940,948

(22) Filed: Mar. 29, 2018

Related U.S. Application Data
(60) Provisional application No. 62/478,267, filed on Mar. 29, 2017.

(51) Int. Cl. A61J 17/00

(52) U.S. Cl. CPC A61J 17/008

(57) ABSTRACT

A baby calming device is disclosed herein. The baby calming device includes a shield member having an upper and lower portion, a plurality of apertures located in the upper portion of the shield member, a protrusion extending from a top surface of the shield member, and an elongate member extending from a bottom surface of the shield member. The elongate member includes a plurality of segments having grooves and projections. The present device is useful for calming a baby while providing novel entertainment to others surrounding the baby.

### CROSS-REFERENCE TO RELATED APPLICATION(S)

The present application is related to and claims priority to U.S. Provisional Patent Application No. 62/478,267 filed Mar. 29, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of amusement toys of existing art and more specifically relates to baby mouthpiece devices.

### RELATED ART

Many parents often use pacifiers to keep a baby calm. A pacifier, binky or soother, and teether is a rubber, plastic, or silicone nipple given to an infant to suck upon. In its standard appearance it has a teat, mouth shield, and handle. The mouth shield and/or the handle is large enough to avoid the danger of the child choking on it or swallowing it.

Similarly, hunting enthusiasts are always looking for hunting memorabilia, especially items they can share with their young children. Additionally, when children lose a pacifier, they tend to panic, scream, and cry, thereby forcing parents to frantically scramble to find a new and clean one. Afterward, parents typically need something to laugh about and remind them how trivial the situation really is. A suitable solution is desired.

U.S. Pat. No. 5,318,590 to Timothy E. Brennan, et al. relates to an infant mask. The described infant mask includes an infant mask having contoured features in relief held in place by a nipple inserted in the infant's mouth. In one embodiment, the contoured mask is removably connected to the nipple. In a second embodiment the mask is made to change shapes as a result of pressure applied to the nipple.

### SUMMARY OF THE INVENTION

In view of the foregoing disadvantages inherent in the known amusement toys art, the present disclosure provides a novel baby calming device. The general purpose of the present disclosure, which will be described subsequently in greater detail, is to provide a baby pacifier or teething device that may be used for entertainment purposes while calming a baby.

A baby calming device is disclosed herein. The baby calming device may include a shield member having an upper and lower portion, a plurality of apertures located in the upper portion of the shield member, a protrusion extending from a top surface of the shield member, and an elongate member extending from a bottom surface of the shield member. The elongate member may itself include a plurality of segments having grooves and projections. The present device may be useful for calming a baby while providing novel entertainment to others surrounding the baby.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a baby calming device, constructed and operative according to the teachings of the present disclosure.

FIG. 1 is a perspective view of the baby calming device during an ‘in-use’ condition, according to an embodiment of the disclosure.

FIG. 2 is a top perspective view of the baby calming device of FIG. 1, according to an embodiment of the present disclosure.

FIG. 3 is a side view of the baby calming device of FIG. 1, according to an embodiment of the present disclosure.

FIG. 4 is an alternate side view of the baby calming device of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a amusement toys and more particularly to a baby calming device as used to provide a baby pacifier or teething device that may be used for entertainment purposes while calming a baby.

Generally, the present invention provides a novelty pacifier for infants that may resemble a duck or game call. It may amuse parents in otherwise stressful situations in which babies are crying or screaming. It can be easier to find when lost, dropped, or thrown. It also introduces young children to the sport of hunting at a young age. The present invention may double as a clever baby shower gift or gag gift for avid hunting families.

The baby calming device of this disclosure may comprise a novelty pacifier for infants with a bulbous nipple and a mouth shield, coupled to a duck or game call. The attached call can be a smaller, weight-reduced version of a standard call, making it easy for an infant to retain the pacifier in their mouth, and can be made from wood or other material with the resemblance of wood. The exact specifications may vary upon manufacturing.

Upon reading this specification, it should be appreciated that, under appropriate circumstances, considering such issues as user preferences, design preference, structural requirements, marketing preferences, cost, available materials, technological advances, etc., other baby calming device arrangements such as, for example, alternative duck calls or configurations, etc., may be sufficient.

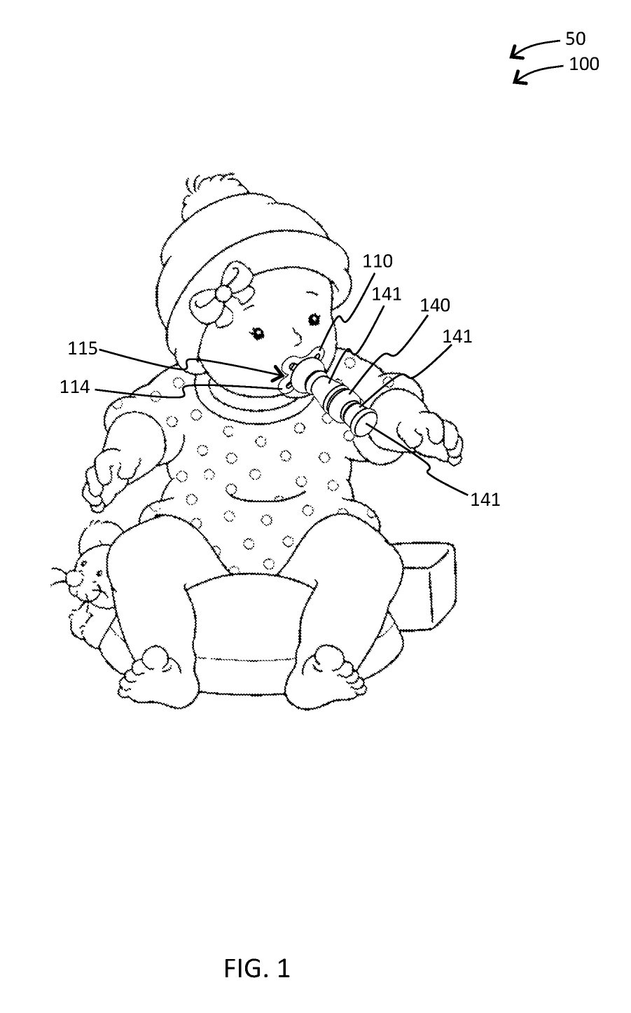

Referring now more specifically to the drawings by numerals of reference, there is shown in FIGS. 1-4, various views of a baby calming device 100.

FIG. 1 shows a baby calming device 100 during an ‘in-use’ condition 50, according to an embodiment of the present disclosure. Here, the baby calming device 100 may be beneficial for use by a user to provide a baby pacifier or teething device that may be used for entertainment purposes while calming a baby. As illustrated, the baby calming device 100 may include a shield member 110 having a curvature 115 and an elongate member 140 extending from a bottom surface 114 of said shield member 110. The elongate member 140 may also include a plurality of segments 141 configured to represent a weight-reduced duck or game call.

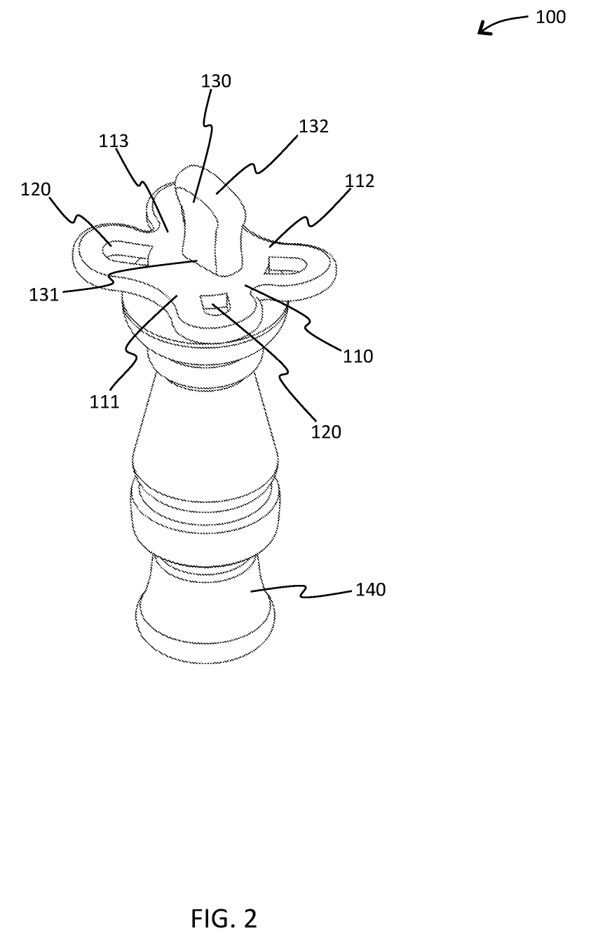

FIG. 2 shows the baby calming device 100 of FIG. 1, according to an embodiment of the present disclosure. As above, the baby calming device 100 may include a shield member 110 having an upper portion 111 and a lower portion 112. The device 100 may also include a plurality of apertures 120 located in the upper portion 111 of the shield member 110. The shield member 110 may include an elongate member 140 that extends from a portion of the shield member 110. Further still the device 100 may feature a protrusion 130 extending from a top surface 113 of the shield member 110. The protrusion 130 may include a first end 131 and a second end 132, wherein the second end 132 may have a curved shape.

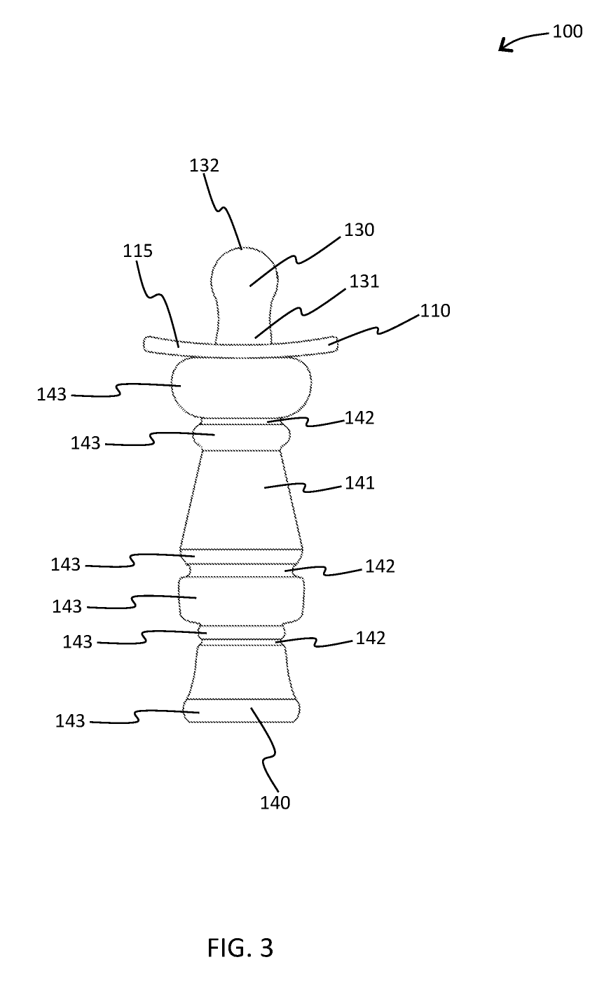

FIG. 3 is a side view of the baby calming device 100 of FIG. 1, according to an embodiment of the present disclosure. Here again, the device 100 may include a shield member 110 having a curvature 115 and an elongate member 140 extending from said shield member 110. The elongate member 140 may have a plurality of segments 141 including a plurality of grooves 142 and a plurality of projections 143. The device 100 may also feature a protrusion 130 extending from the shield member 110. The protrusion 130 may include a first end 131 and a second end 132, wherein the second end 132 may have a curved shape.

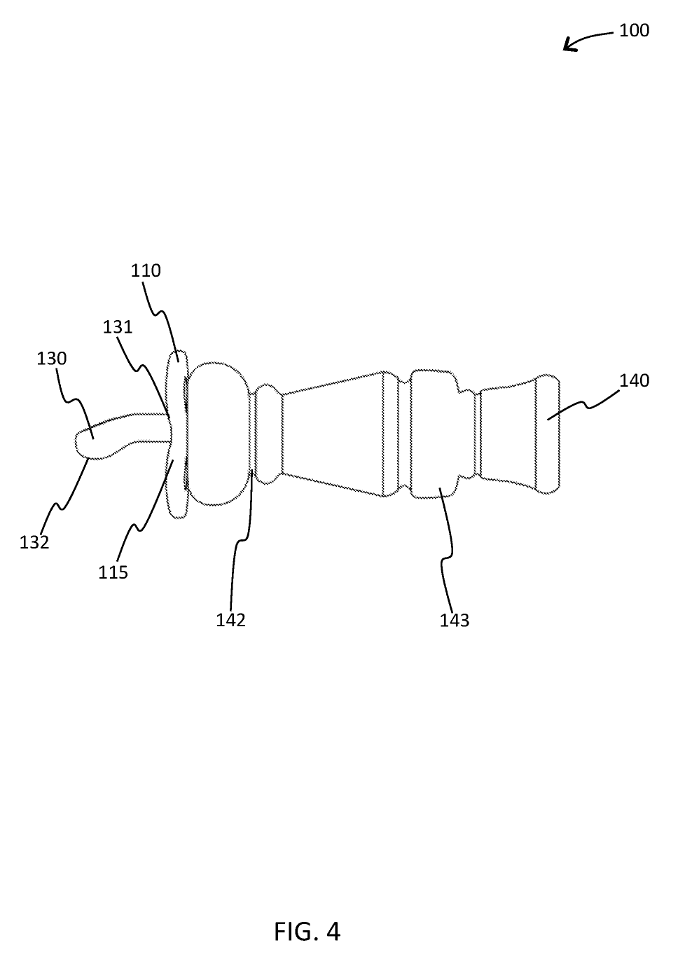

FIG. 4 is an alternate side view of the baby calming device 100 of FIG. 1, according to an embodiment of the present disclosure. As above, the baby calming device 100 may include a a shield member 110 having a curvature 115, a protrusion 130, and an elongate member 140 extending from the shield member 110. The elongate member 140 may include a plurality of grooves 142 and a plurality of projections 143 configured to replicate the arrangement of a duck call. The protrusion 130 may include a first end 131 and a second end 132, wherein the second end 132 may have a curved shape that allows for oral pacifying of an infant.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for calming a baby, comprising:
a shield member, said shield member having an upper portion and a lower portion;
a plurality of apertures, said plurality of apertures located in said upper portion of said shield member;
a protrusion, said protrusion extending from a top surface of said shield member; and
an elongate member, said elongate member extending from a bottom surface of said shield member;
wherein said elongate member has a plurality of segments, said plurality of segments including a plurality of grooves and a plurality of projections;
wherein said shield member has a non-planar configuration;
wherein a periphery of said shield member has a curvature; and
wherein said device is configured to calm a baby.

2. The device of claim 1, wherein said protrusion extends from a top-surface-central portion of said shield member.

3. The device of claim 1, wherein said elongate member extends from a bottom-surface-central portion of said shield member.

4. The device of claim 1, wherein said protrusion has a first end and a second end.

5. The device of claim 4, wherein said second end has a curved shape.

6. The device of claim 4, wherein said second end has a width greater than a first-end-width of said protrusion.

7. The device of claim 1, wherein said protrusion is a bulbous member.

8. The device of claim 1, wherein said top surface of said shield member is concave.

9. The device of claim 1, wherein said bottom surface of said shield member is convex.

10. The device of claim 1, wherein said elongate member is a handle.

11. The device of claim 1, wherein said plurality of segments comprises 9 segments.

12. The device of claim 1, wherein said device is a pacifier.

13. The device of claim 1, wherein said protrusion is made of a material selected from the group consisting of rubber, plastic, and silicone.

14. The device of claim 1, wherein said elongate member is made of wood.

15. The device of claim 1, wherein one of said plurality of segments is a base of said elongate member.

16. The device of claim 1, wherein said plurality of segments comprises 3 grooves and 6 projections.

17. A device for calming a baby, comprising:
a shield member, said shield member having an upper portion and a lower portion;
a plurality of apertures, said plurality of apertures located in said upper portion of said shield member;
a protrusion, said protrusion extending from a top surface of said shield member; and
an elongate member, said elongate member extending from a bottom surface of said shield member;
wherein said elongate member has a plurality of segments, said plurality of segments including a plurality of grooves and a plurality of projections;
wherein said shield member has a non-planar configuration;
wherein a periphery of said shield member has a curvature;
wherein said protrusion extends from a top-surface-central portion of said shield member;
wherein said elongate member extends from a bottom-surface-central portion of said shield member;
wherein said protrusion has a first end and a second end;
wherein said second end has a curved shape;
wherein said second end has a width greater than a first-end-width of said protrusion;
wherein said protrusion is a bulbous member;
wherein said top surface of said shield member is concave;
wherein said bottom surface of said shield member is convex;
wherein said elongate member is a handle;
wherein said plurality of segments comprises 9 segments;
wherein said device is a pacifier;
wherein said protrusion is made of a material selected from the group consisting of rubber, plastic, and silicone;
wherein said elongate member is made of wood;
wherein one of said plurality of segments is a base of said elongate member;
wherein said plurality of segments comprises 3 grooves and 6 projections; and
wherein said device is configured to calm a baby.
